(19) United States
(12) Patent Application Publication
(10) Pub. No.: US 2019/0240796 A1
(43) Pub. Date: Aug. 8, 2019

(54) SPIN WINDOWS WITH INTEGRATED CAMERAS

(71) Applicants: R. Sean BLECHSCHMIDT, Clyde Hill, WA (US); Wolfgang J. BLECHSCHMIDT, Bellevue, WA (US)

(72) Inventors: R. Sean BLECHSCHMIDT, Clyde Hill, WA (US); Wolfgang J. BLECHSCHMIDT, Bellevue, WA (US)

(21) Appl. No.: 16/331,931

(22) PCT Filed: Sep. 8, 2017
(86) PCT No.: PCT/US2017/050646

§ 371 Date: Mar. 8, 2019

Related U.S. Application Data
(60) Provisional application No. 62/385,807, filed on Sep. 9, 2016.

(51) Int. Cl. B23Q 11/08; B23Q 17/24

(52) U.S. Cl. CPC B23Q 11/0891; B08B 17/02; B23Q 17/2409

(57) ABSTRACT

A spin window (100) can include an integrated camera (108) and a rotatable window (106) in a single integrated or modular unit. The spin window can include a stationary outer rim (120), a motor (138), a central hub (104) to couple the rotatable window to the motor, and a rotatable outer rim coupled to the rotatable window. The camera can be positioned behind the rotatable window so that it is protected from debris cast against the spin window. The spin window can be positioned within a machine tool safety enclosure.

### BACKGROUND

### Technical Field

The present disclosure relates to spin windows with integrated cameras.

### Description of the Related Art

Spin windows provide windows that spin rapidly to prevent debris from accumulating on the window. In some implementations, a spin window is incorporated into an outer wall of a machine tool safety enclosure, so that an operator or a camera can clearly view the operation of the machine tools within the safety enclosure from outside the enclosure, even when the machine tools cast liquid or solid debris onto the enclosure's walls. Additional details regarding spin windows are available in U.S. Pat. No. 5,161,055.

### BRIEF SUMMARY

A spin window may be summarized as comprising: a rotatable, transparent window including an outer edge portion and a first central longitudinal axis; a rotatable rim coupled to the outer edge portion of the rotatable, transparent window and including a second central longitudinal axis coincident with the first central longitudinal axis; and a camera, wherein at least a portion of the camera is positioned directly radially inward from the rotatable rim.

A spin window may be summarized as comprising: a rotatable, transparent window including an outer edge portion and a first central longitudinal axis; a rotatable rim coupled to the outer edge portion of the rotatable, transparent window and including a second central longitudinal axis coincident with the first central longitudinal axis; and a camera, wherein a first position of at least a portion of the camera overlaps with a second position of the rotatable rim along a dimension parallel to the first and second central longitudinal axes.

A spin window may be summarized as comprising: a rotatable, transparent window including a first central longitudinal axis; a motor coupled to the rotatable, transparent window and including a second central longitudinal axis coincident with the first central longitudinal axis; and a camera, wherein at least a portion of the camera is positioned directly radially outward from the motor.

A spin window may be summarized as comprising: a rotatable, transparent window including a first central longitudinal axis; a motor coupled to the rotatable, transparent window and including a second central longitudinal axis coincident with the first central longitudinal axis; and a camera, wherein a first position of at least a portion of the camera overlaps with a second position of the motor along a dimension parallel to the first and second longitudinal axes.

At least a portion of a camera may include at least a lens of the camera. A spin window may be completely enclosed within outer walls of a machine tool safety enclosure.

A spin window may be summarized as comprising: a housing including an outer rim; a notch formed in the outer rim; a first bracket including a main body and a flange, the bracket coupled to the outer rim with the flange positioned in the notch; a second bracket coupled to the first bracket; and a camera coupled to the second bracket. The camera may be sealed to the housing with a nitrile sleeve.

A spin window may be summarized as comprising: an outer stationary rim; a stationary support arm extending radially inward from the outer stationary rim; a first protrusion coupled to and extending transverse to the stationary support arm; a second protrusion coupled to and extending radially inward from the outer stationary rim; and a camera constrained against lateral movement by the outer stationary rim, the stationary support arm, the first protrusion, and the second protrusion.

### BRIEF DESCRIPTION OF THE SEVERAL VIEWS OF THE DRAWINGS

FIG. 1 is a perspective view of a spin window with an integrated camera, according to at least one illustrated embodiment.

FIG. 2 is an exploded perspective view of some components of the spin window of FIG. 1.

FIG. 3 is another perspective view of the spin window of FIG. 1.

FIG. 4 is a perspective view of the spin window of FIG. 1 with a rear camera cover removed.

FIG. 5 is a perspective view of the spin window of FIG. 4 with a rear cover removed.

FIG. 6 is a perspective view of the spin window of FIG. 5 with various internal components of the spin window removed.

FIG. 7 is another perspective view of the spin window of FIG. 6.

FIG. 8 is another perspective view of the spin window of FIG. 6.

FIG. 9 is a perspective view of the spin window of FIG. 1 with some components removed.

FIG. 10 is a perspective view of a spin window with an integrated camera, according to at least one illustrated embodiment.

FIG. 11 is another perspective view of the spin window of FIG. 10.

FIG. 12 is another perspective view of the spin window of FIG. 10.

FIG. 13 is a perspective view of the spin window of FIG. 10 without the integrated camera.

FIG. 14 is a perspective view of the spin window of FIG. 10 with some components removed.

FIG. 15 illustrates a spin window positioned within a machine tool safety enclosure, according to at least one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

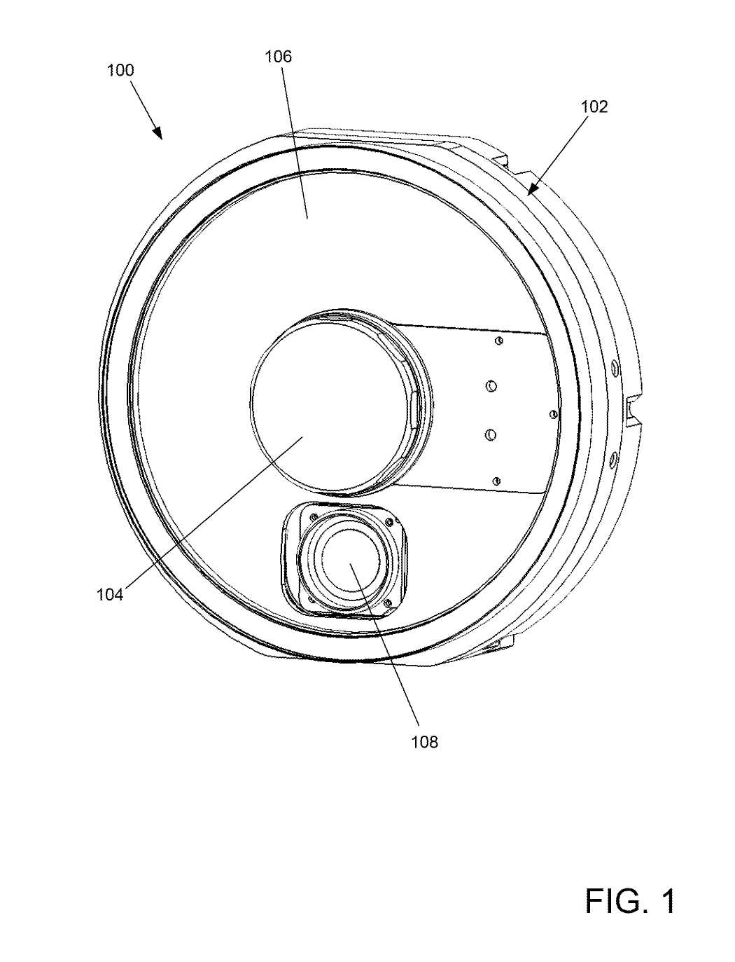

FIG. 1 shows a spin window 100 that includes an outer, annular frame 102 that has a generally hollow, cylindrical shape. The outer, annular frame 102 includes several smaller annular rings adjacent to and sealed to one another to form the frame 102, as described further below. The spin window 100 also includes a central hub 104 that has a generally cylindrical shape, and that is coaxial with the outer, annular frame 102. The spin window 100 also includes a transparent sheet of material 106, which can comprise a transparent glass or plastic material, and which spans the annular area between the outer, annular frame 102 and the central hub 104, such as between an inner surface of the outer, annular frame 102 and an outer surface of the central hub 104.

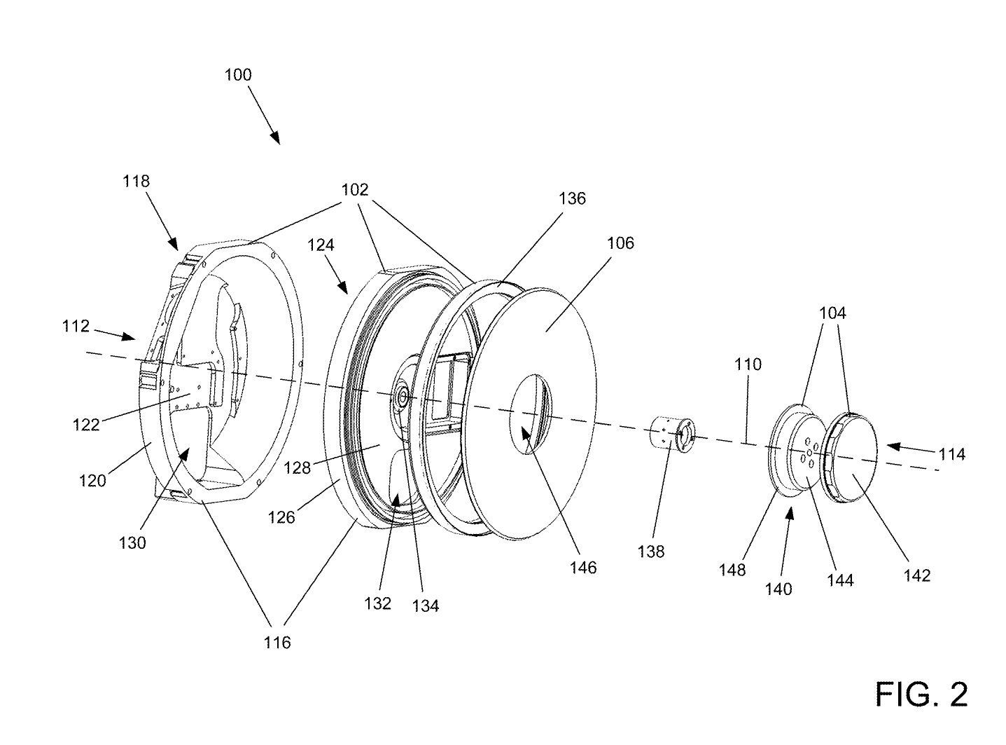

The transparent sheet of material 106 can be referred to herein as a rotatable window 106, and is further described below with regard to FIG. 2, in which it is illustrated as being opaque despite actually being transparent for purposes of clarity. The spin window 100 also includes an integrated camera 108, which can record video, capture still images, or both. The integrated camera 108 is positioned radially between the outer, annular frame 102 and the central hub 104, and is positioned behind the rotatable window 106. The rotatable window 106 is rigidly coupled to the central hub 104, and the rotatable window 106 and the central hub 104 are rotatable together along their central longitudinal axes.

When the spin window 100 is in use, it can be mounted inside a machine tool safety enclosure, where debris from machining operations may be cast onto the rotatable window 106. The spin window 100 can be used to rotate the rotatable window 106 at high speeds about its central longitudinal axis, so that any solid or liquid debris that contacts the rotatable window 106 is quickly thrown radially outward and off of the rotatable window 106. In doing so, the rotatable window 100 can provide and maintain a clear field of view inside the machine tool safety enclosure, and of the machinery operating therein, for the camera 108.

FIG. 2 shows an exploded view of some components of the spin window 100, wherein the components are spaced apart from one another along a central longitudinal axis 110 of the spin window 100 that is coincident with the central longitudinal axes of the outer, annular frame 102, the central hub 104, and the rotatable window 106. FIG. 2 illustrates that the spin window 100 includes a rear end portion 112 along the axis 110, a front end portion 114 along the axis 110, and various components positioned between the rear and front end portions 112, 114.

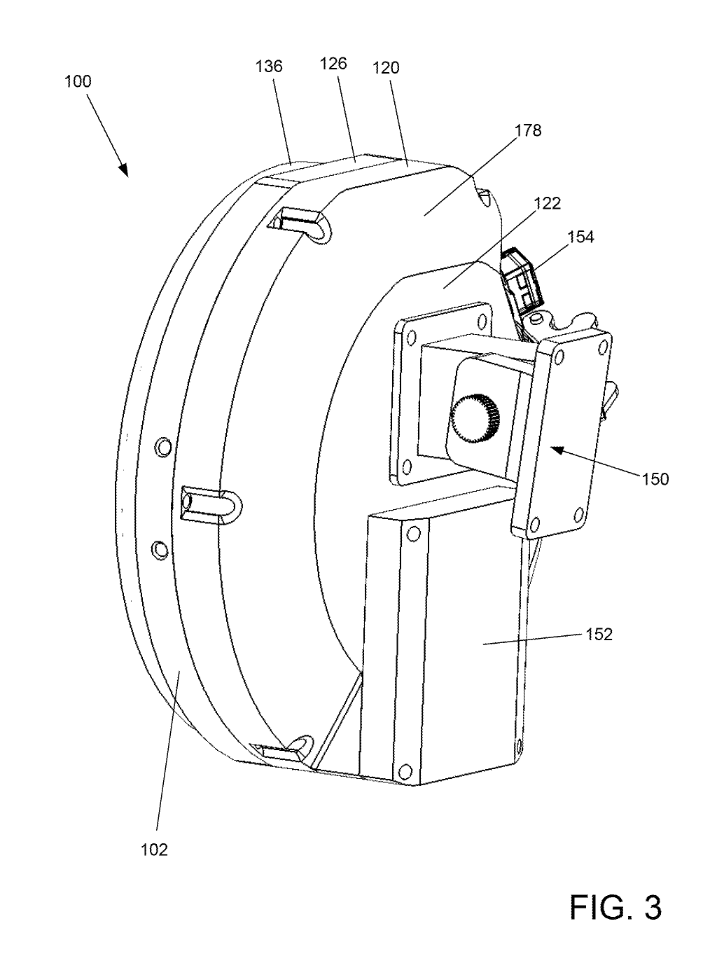

At its rear end portion 112, the spin window 100 includes a housing 116 configured to house and protect various other components of the spin window 100, as described further below. The housing 116 includes a rear portion or rear cover 118 that includes a cylindrical outer rim 120 and a rear plate 122. As seen in FIG. 3, the cylindrical outer rim 120 extends generally perpendicularly to the rear plate 122, and the rear cover 118 includes a chamfer 178 that extends between the outer rim 120 and the rear plate 122 around substantially the entirety of the circumference of the rear cover 118. The chamfer 178 reduces the total volume of the housing 116 and of the spin window 100 overall, thereby reducing the extent to which the spin window 100 interferes with the positioning of other devices in its vicinity, such as within a machine tool safety enclosure. This can provide an operator with greater flexibility in positioning the spin window 100 and machine tools within a single enclosure.

The housing 116 also includes a front portion or front cover 124 that includes a cylindrical outer rim 126 and a front plate 128. The rear plate 122 is coupled to a rear end of the outer rim 120 and the front plate 128 is coupled to a front end of the outer rim 126. Thus, a front end of the rim 120 of the rear cover 118 can be coupled to a rear end of the rim 126 of the front cover 124 to assemble the housing 116 with a cylindrical internal empty space or void defined by the inner surfaces of the rims 120 and 126, for holding various other components of the spin window 100 between the rear plate 122 and the front plate 128.

Viewed along the axis 110, the rear plate 122 spans the majority of, or substantially the entirety of, the area encompassed within the rim 120 of the rear cover 118. Similarly, viewed along the axis 110, the front plate 126 spans the majority of, or substantially the entirety of, the area encompassed within the rim 126 of the front cover 124. The rear plate 122 and the front plate 128 include, however, respective openings 130 and 132 that are aligned with one another in the direction of a dimension parallel to the axis 110. These openings can be sized to accommodate the camera 108, such that the camera 108 can be inserted into and removed from the housing 116 through the opening 130 in the rear cover 118 and such that the camera 108 can be oriented with its field of view extending outward through the opening 132 in the front cover 124. FIG. 2 also illustrates that the front plate 128 of the front cover 124 includes a circular stand or pedestal 134, to which an electric motor, or a stationary component of an electric motor, or a stator, can be coupled or mounted.

FIG. 2 also shows the rotatable window 106, which is illustrated as being opaque, despite the rotatable window 106 actually being transparent, for purposes of clarity. The rotatable window 106 is a thin sheet of transparent material having an overall circular shape and therefore a cylindrical outer surface, and a circular aperture 146 at its center. Both the cylindrical outer surface and the circular aperture 146 of the rotatable window 106 are coaxial with the axis 110. FIG. 2 also shows that the spin window 100 includes a cylindrical, opaque outer rim 136 that can be rigidly coupled and sealed to the outer surface of the rotatable window 106. When the spin window 100 operates, the opaque outer rim 136 can be sealed to and rotatable with respect to the front of the housing 116, such as a front end portion of the front cover 124. FIG. 2 illustrates that the outer, annular frame 102 of the spin window 100 can comprise the rim 120 of the rear cover 118, the rim 126 of the front cover 124, and the rim 136.

FIG. 2 also shows an electric motor, or a rotatable component of an electric motor, or a rotor 138. The rotor 138 can be engaged with a stator that is coupled to the pedestal 134 to form an electric motor that is coupled to the front surface of the front cover 124 by the pedestal 134. FIG. 2 also shows that the central hub 104 can include a rear backing plate 140 and a front face plate 142. The backing plate 140 includes a front cylindrical portion 144 having an outer diameter matching an inside diameter of the circular aperture 146, and a circumferential flange 148 extending radially outward from a rear end portion of the front cylindrical portion 144.

To assemble the spin window 100, the rim 136 can be coupled to the rotatable window 106. The rotatable window 106 can be positioned with the cylindrical portion 144 of the backing plate 140 extending through its circular aperture 146. The face plate 142 can be coupled to the rotatable window 106 and to the backing plate 140 so that the rotatable window 106 is snugly sandwiched, or clamped, between the backing plate 140 and the face plate 142. The backing plate 140 can be coupled to the rotor 138 and thereby to the rest of the spin window 100. To use the spin window 100, the motor including the rotor 138 can be used to spin the rotatable window 106, the rim 136, the backing plate 140, and the face plate 142, at high speeds with respect to the housing 116.

FIG. 3 shows a rear perspective view of the spin window 100. As illustrated in FIG. 3, the spin window 100 includes a hinged bracket 150 that can be used to mount the spin window 100 to a wall or other mounting location. The hinged bracket 150 can allow an operator to adjust the orientation of the spin window 100 and its camera 108 so that their field of view is oriented upward or downward with respect to a horizontal axis. For example, the hinged bracket 150 can be used to adjust the field of view of the camera 108 to be oriented downward at up to about 5°, 10°, 15°, 20°, 25°, 30°, 35°, 40°, or 45° with respect to a horizontal axis. This can allow the spin window 100 to be located near a top portion of a machine tool safety enclosure while being aimed downward toward machine tools operating therein.

The spin window 100 also includes a rear camera cover 152 coupled to a rear surface of the housing 116 to cover the opening 130 in the rear plate 122. The camera cover 152 is removably coupled to the housing 116 so an operator can remove the cover 152 to insert, remove, replace, or perform maintenance on the camera 108, and so that the operator can install the cover 152 to seal the housing 116 to protect the components held therein. The spin window 100 also includes one or more ports 154, which can include data ports, power ports, or any other suitable ports.

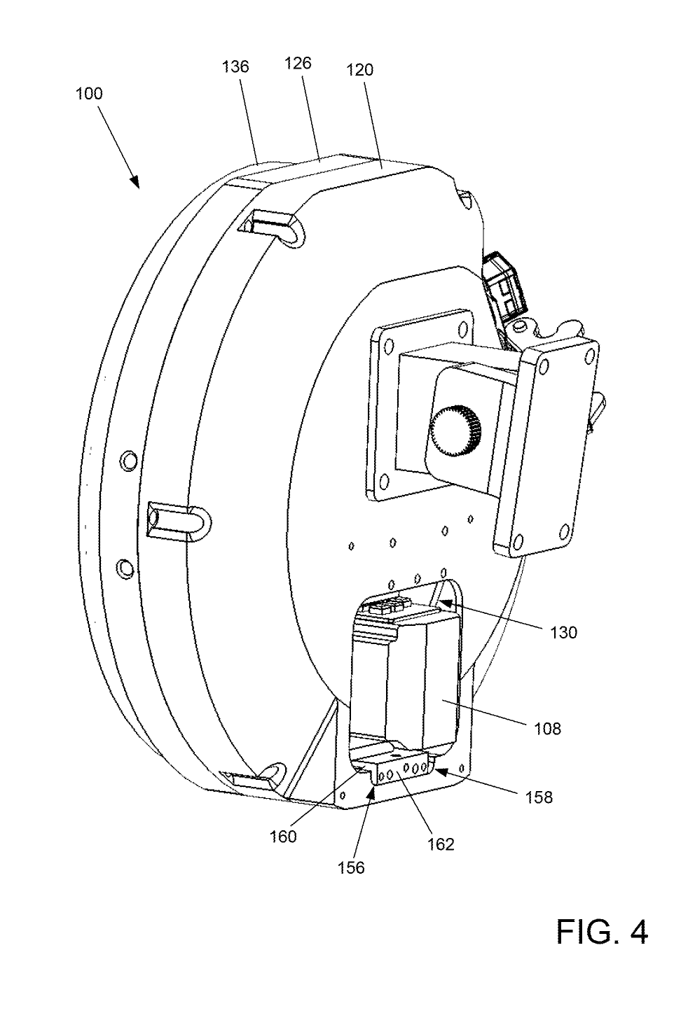

FIG. 4 shows the spin window 100 from the same angle as in FIG. 3, but with the camera cover 152 removed to show that an operator can access the camera 108 through the rear end portion 112 of the spin window 100. FIG. 4 also illustrates a first bracket 156 that can be used to couple the camera 108 to the rear cover 118. For example, the rim 120 of the rear cover 118 can extend rearward at a bottom end of the spin window 100 adjacent to a location where the camera 108 is or will be installed. A recess, groove, or notch 158 is formed in a rear end of the rear cover 118 and in an upper surface of the rearward extension of the rim 120, as a radially-extending expansion of the opening 130. The first bracket 156 has a substantially rectangular main body 160 and a flange 162 that extends radially away from, and transverse or perpendicular to, the main body 160. The flange 162 can be seated within the notch 158 and screwed into the rear cover 118 to secure the first bracket 156 to the rear cover 118. Thus, the first bracket 156 can be secured to the rear cover 118 to extend through the opening 130.

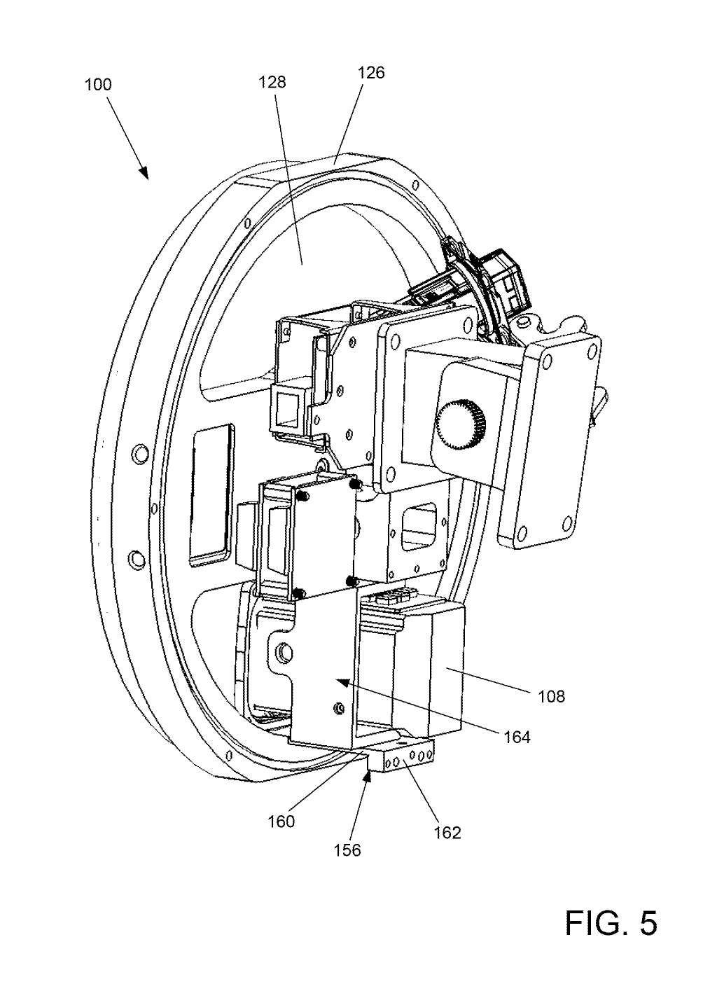

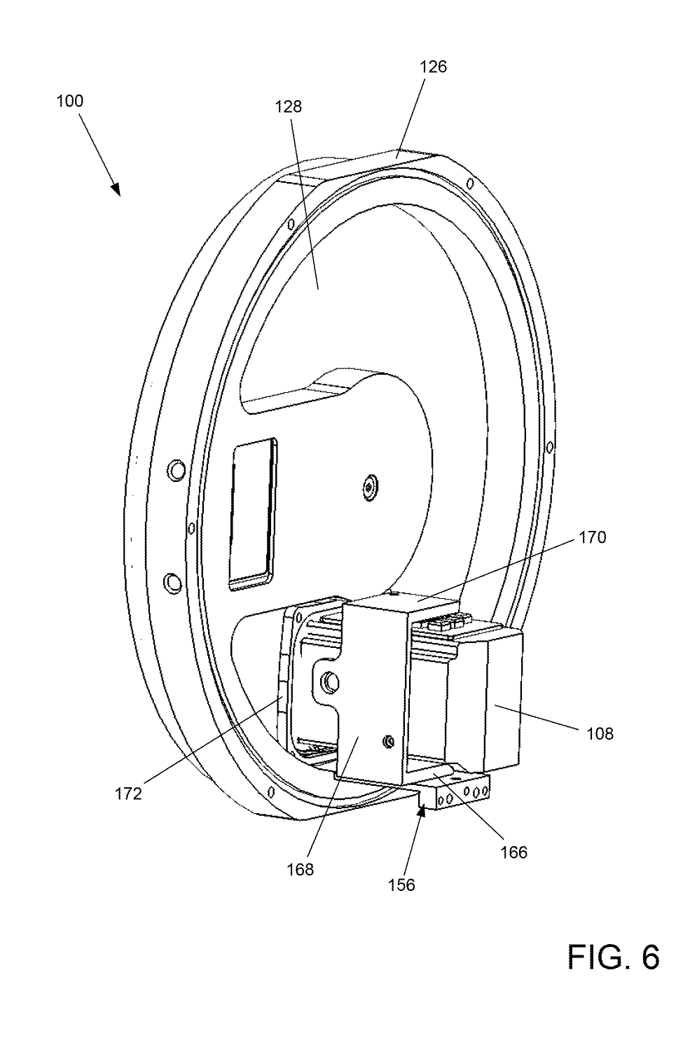

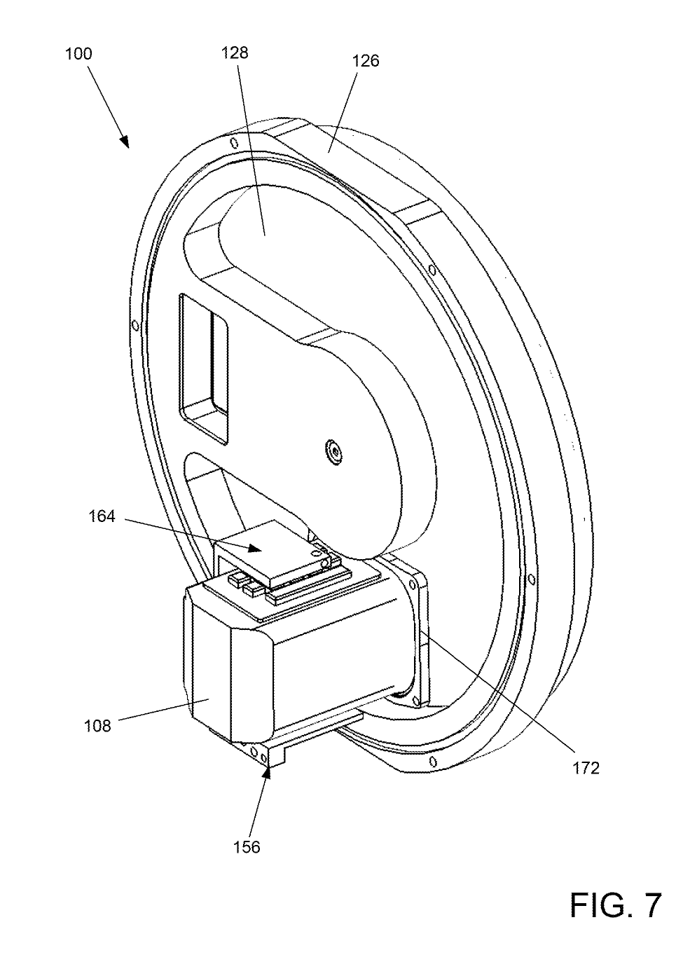

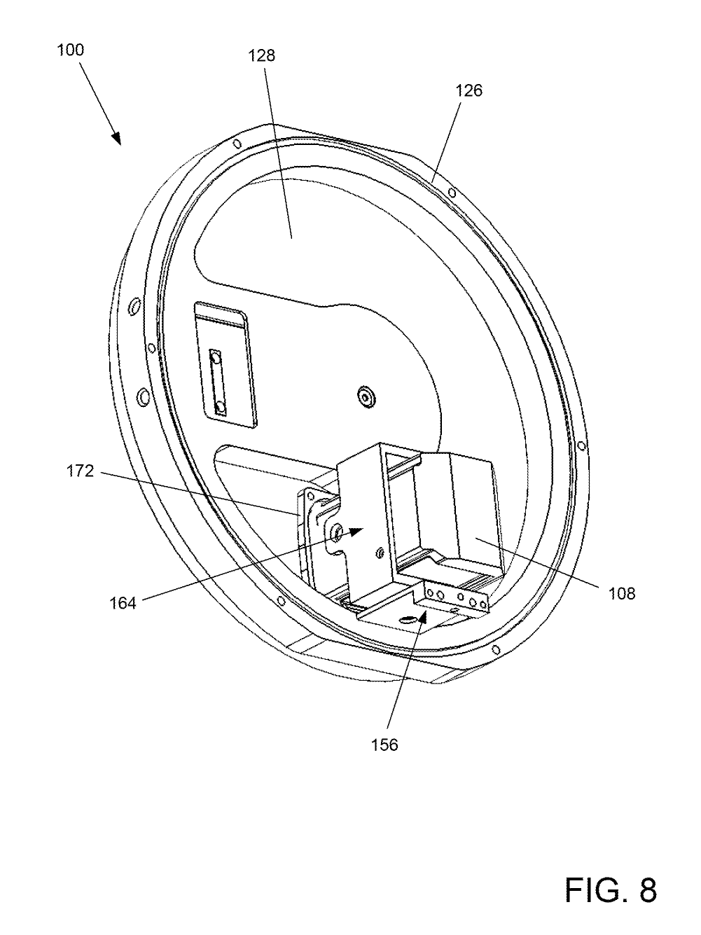

FIG. 5 shows the spin window 100 as in FIG. 4, but with the rear cover 118 of the housing 116 removed to show a variety of components held within the housing 116. Some of these components are not described in detail in this specification. FIGS. 6-8 show the spin window 100 as in FIG. 5, but with a variety of internal components of the spin window 100 removed to more clearly illustrate other components. As illustrated in FIGS. 6-8, the camera 108 is mounted to the housing 116 by the first bracket 156 and by a second bracket 164. As described above, the first bracket 156 is coupled to the rear cover 118 to extend through the opening 130.

The second bracket 164 is a C-shaped bracket having a generally rectangular first arm portion 166, a generally rectangular body portion 168 extending transverse or perpendicular to the first arm portion 166, and a generally rectangular second arm portion 170 extending transverse or perpendicular to the body portion 168 and aligned with or parallel to the first arm portion 166. The first arm portion 166 is mounted flush to the main body 160 of the first bracket 156 so that the body portion 168 extends from the first arm portion 166 toward the central axis 110, and so that the second arm portion 170 is located closer to the axis 110 and the center of the spin window 100 than the first arm portion 166. The camera 108 is mounted to the second bracket 164 between the first and second arm portions 166, 170. FIGS. 6-8 also illustrate that the spin window 100 includes a seal 172 positioned to seal the camera 108, which extends through the opening 132 in the front cover 124, to the front cover 124. In some cases, the seal 172 includes a nitrile sleeve.

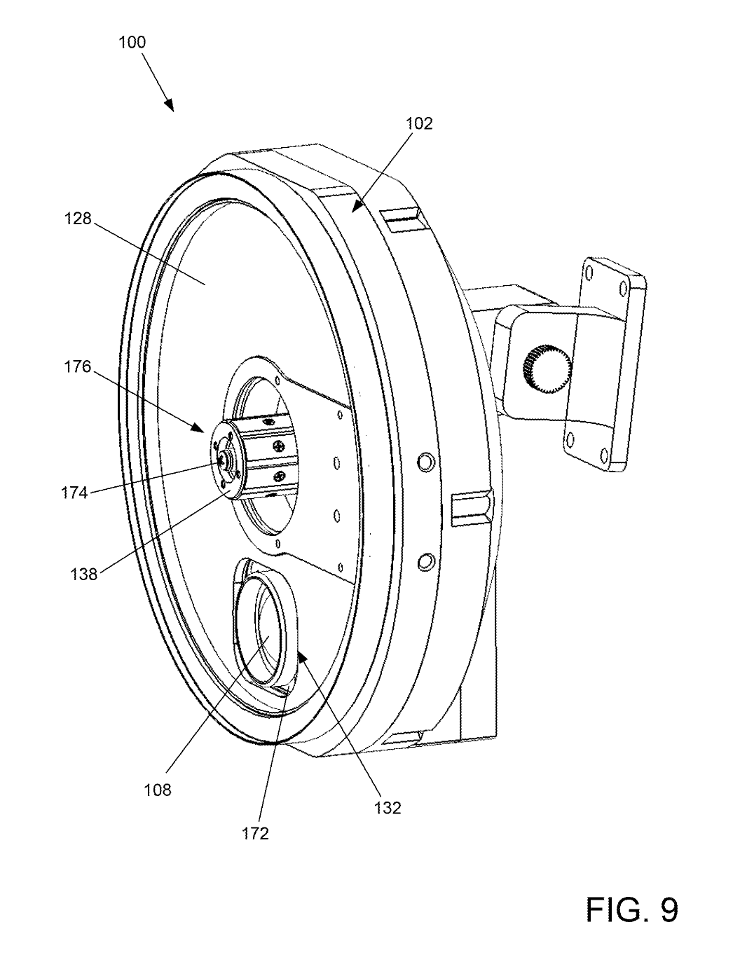

FIG. 9 shows a front perspective view of the spin window 100 with the rotatable window 106 and the central hub 104 removed to more clearly illustrate other components, such as an electric motor 176 including a stator 174 and the rotor 138. As illustrated in FIG. 9, a portion of the camera 108, such as a front end portion or a front lens of the camera 108, can extend through the opening 132 in the front plate 128, and can be positioned directly radially inward from the rim 136. The electric motor 176 can be positioned at the center of the spin window 100 so that its central longitudinal axis is coincident with the axis 110, and a portion of the camera 108, such as the front end portion or front lens of the camera 108, can be positioned directly radially outward from the motor 176. Put another way, the position of a portion of the camera 108, such as the front end portion or front lens of the camera 108, along the dimension parallel to the axis 110 can overlap with the position of the motor 176 and/or the position of the rim 136 along the dimension parallel to the axis 110.

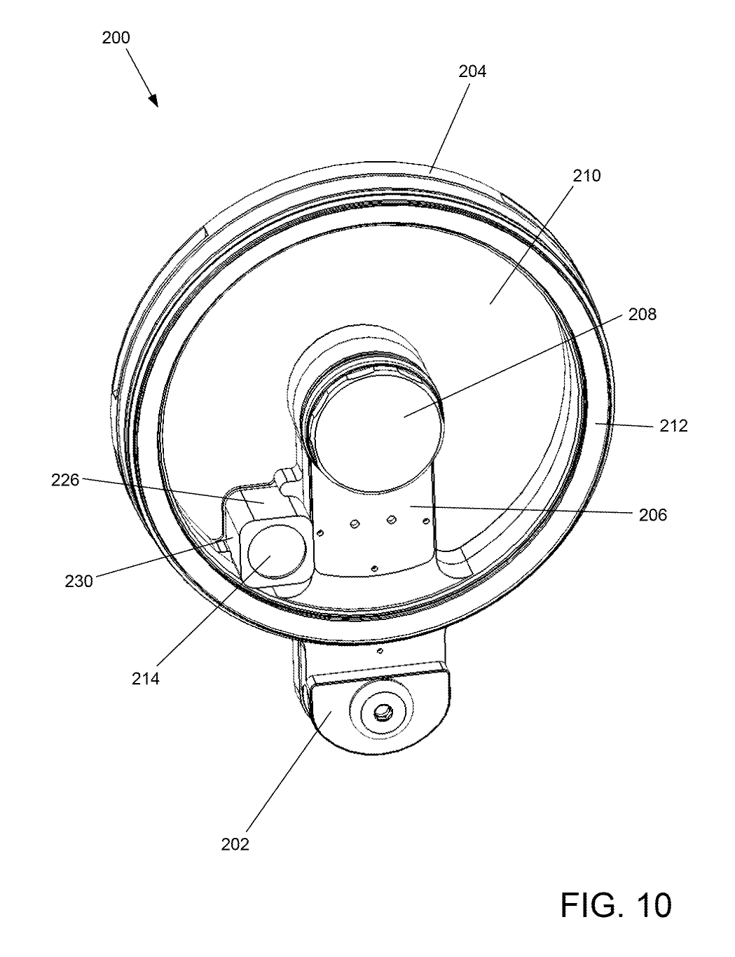

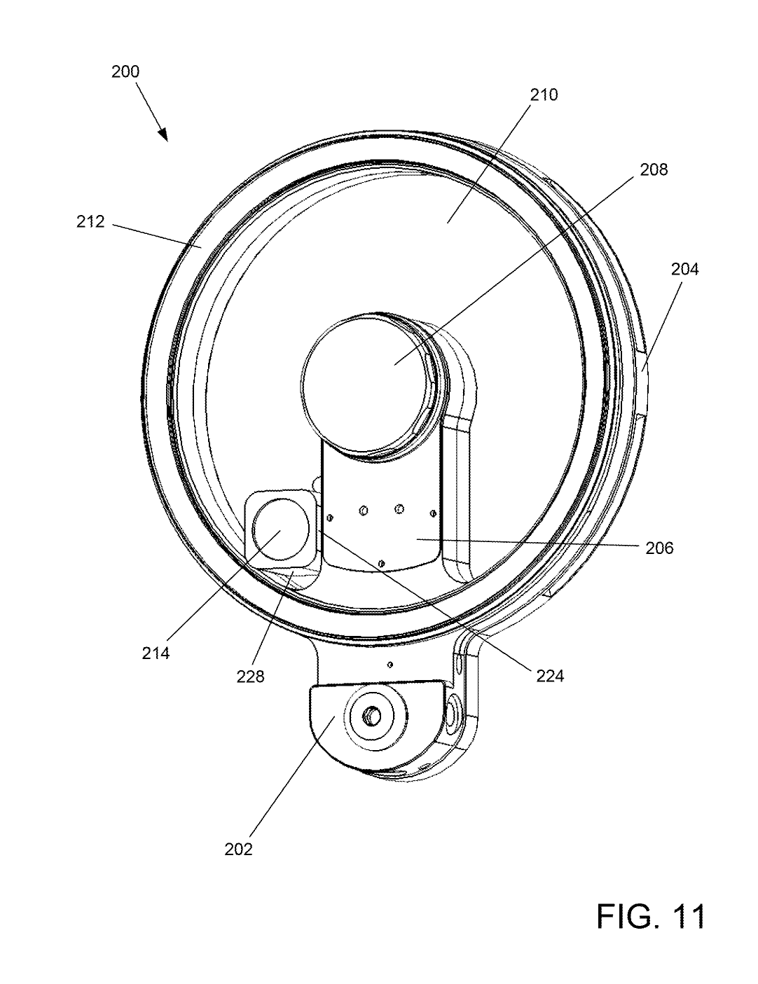

FIG. 10 shows another embodiment of a spin window 200. The spin window 200 has some features that are the same as those described above for the spin window 100, and has some features that are different than those described above for the spin window 100. FIGS. 10 and 11 show that the spin window 200 includes a support post 202, which can be used to couple the spin window 200 to other objects. The spin window 200 also includes an outer, annular, stationary rim 204 coupled to the support post 202. The spin window 200 also includes a radially extending stationary arm 206 that extends inward from the stationary rim 204 to the center of the annular, stationary rim 204. A central hub 208 that is similar to the central hub 104 is rotatably coupled to a front surface of the end of the arm 206 at the center of the annular rim 204.

A transparent sheet of material 210, referred to herein as a rotatable window 210, and that is similar to the rotatable window 106, is rigidly mounted to the central hub 208. An outer, annular, rotatable rim 212, which is similar to the rim 136, is rigidly coupled and sealed to the outer surface of the rotatable window 106. When the spin window 200 operates, the rotatable rim 212 can be sealed to and rotate with respect to the front of the stationary rim 204. FIGS. 10 and 11 also show that the spin window 200 includes an integrated camera 214, which can be positioned adjacent to and in direct contact with the arm 206, the stationary rim 204, and the rotatable rim 212. The camera 214 can be positioned behind the rotatable window 210, so that it is protected from projectiles or liquid or solid debris cast toward the spin window 200 during use.

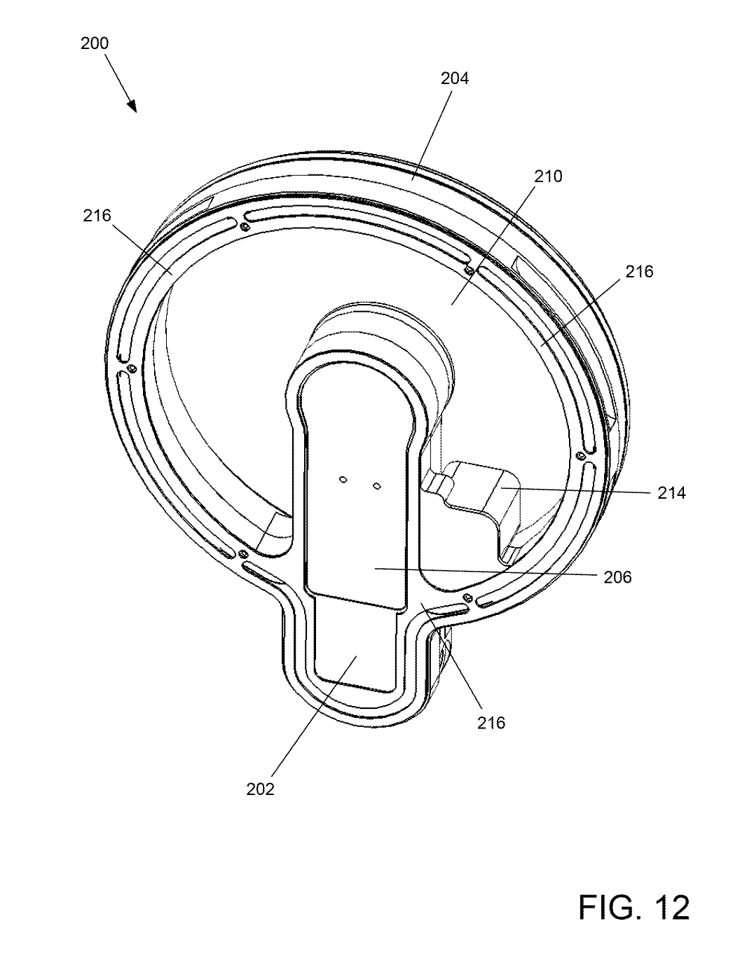

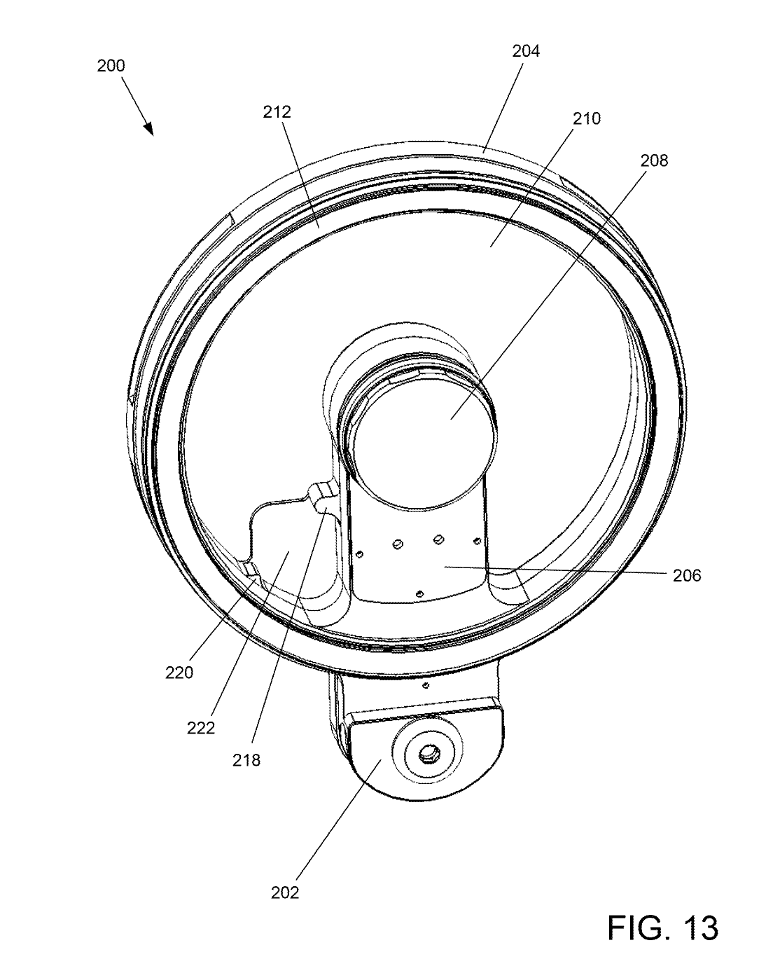

FIG. 12 shows a rear view of the spin window 200. As illustrated in FIG. 12, a rear surface of the spin window 200 includes an adhesive and/or a seal 216 that can be used to mount the spin window 200 to a stationary window or other surface, and to provide a seal therewith. FIG. 13 shows a front view of the spin window 200 with the camera 214 removed. As illustrated in FIG. 13, a first protrusion 218 extends outward from, and transverse or perpendicular to, a side surface of the radial arm 206, and a second protrusion 220 extends radially inward from an inner surface of the stationary rim 204 in a direction oriented toward the central hub 208. A backing plate 222 extends along a plane parallel to a plane of the rotatable window 210, and is positioned at the rear end of the spin window 200. The backing plate 222 extends radially inward from the stationary rim 204 between the radial arm 206 and the second protrusion 220, and extends outward from the side surface of the radial arm 206 between the stationary rim 204 and the first protrusion 218. The backing plate 222 forms a web that extends between the stationary rim 204, the radial arm 206, and the first and second protrusions 218 and 220.

When the camera 214 is mounted to the spin window 200, it has a rear surface in contact with the backing plate 222, a front surface behind the rotatable window 210, a first side surface 224 in contact with and constrained against lateral movement by the radial arm 206, a second side surface 226 in contact with and constrained against lateral movement by the first protrusion 218, a third side surface 228 in contact with and constrained against lateral movement by the stationary rim 204, and a fourth side surface 230 in contact with and constrained against lateral movement by the second protrusion 220.

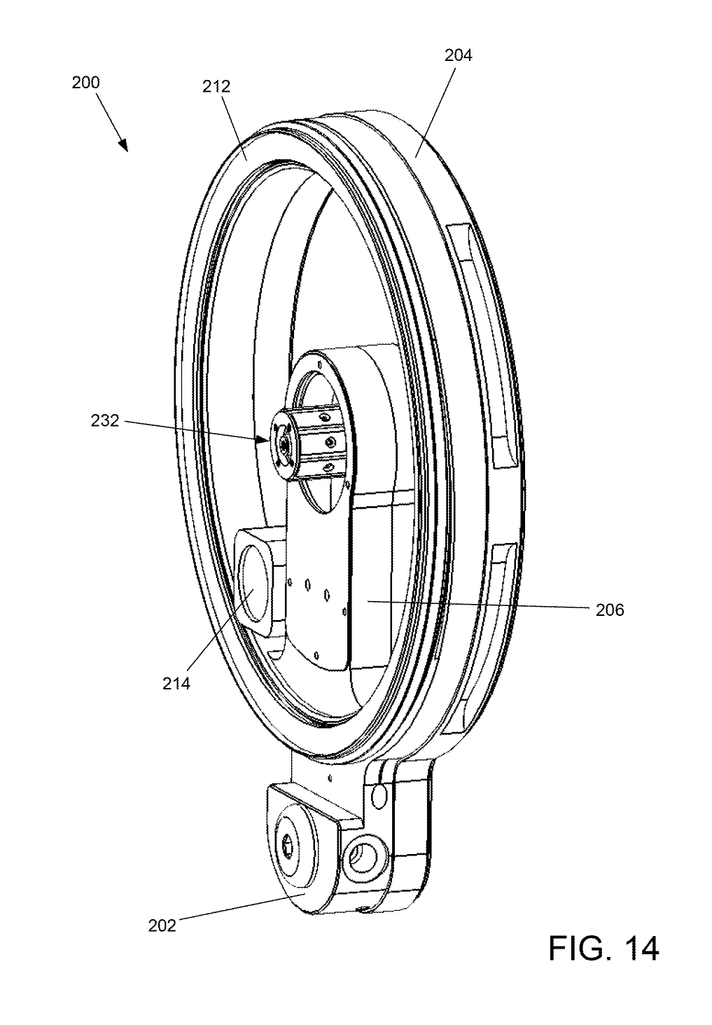

FIG. 14 shows the spin window 200 with the central hub 208 and the rotatable window 210 removed so that an electric motor 232, which is similar to the motor 176, is visible. A stator of the motor 232 is rigidly coupled to the radial arm 206, so that a rotor of the motor 234 can be actuated to rotate with respect to the support post 202, stationary rim 204, radial arm 206, and other components of the spin window 200. The central hub 208, the rotatable window 210, and the rotatable rim 212 are rigidly coupled to one another and are rigidly mounted to the rotor of the motor 232, so that they can be actuated to spin with respect to the support post 202, stationary rim 204, radial arm 206, and other components of the spin window 200.

As illustrated in FIG. 14, a portion of the camera 214, such as a front end portion or a front lens of the camera 214, can be positioned directly radially inward from the rotatable rim 212. The motor 232 can be positioned at the center of the spin window 200 so that its central longitudinal axis is coincident with a central longitudinal axis of the rotatable rim 212, and a portion of the camera 214, such as the front end portion or front lens of the camera 214, can be positioned directly radially outward from the motor 232. Put another way, the position of a portion of the camera 214, such as the front end portion or front lens of the camera 214, along a dimension parallel to the central longitudinal axes of the motor 232 and the rotatable rim 212, can overlap with the position of the motor 232 and/or the position of the rim 212 along the dimension parallel to the central longitudinal axes of the motor 232 and the rotatable rim 212.

The spin window 200 differs from the spin window 100 in that many of its mechanical and electrical components are housed within the support post 202, the stationary rim 204, and/or the radial arm 206. Thus, a person can stand behind and look through the spin window 200, such as through a majority of the area enclosed by the stationary rim 204 or the rotatable rim 212. Alternatively, or in addition, a second camera can be positioned behind the spin window 200 such that its field of view extends through a majority of the area enclosed by the stationary rim 204 or the rotatable rim 212.

The spin windows 100 and 200 each incorporate a rotatable window and a camera into a single modular or integrated unit. Such an integrated unit can be sold as a package and installed very quickly, efficiently, and reliably by an end user, without the need for detailed explanations or training. The spin windows 100 and 200, including their respective cameras 108 and 214, can also be mounted in various locations, positions, and orientations, which can be reliably adjusted as needed without the need to re-calibrate the relative positions or orientations of the cameras 108 and 214 and the respective rotatable windows 106 and 210. Further, the integrated units described herein provide spin windows with integrated cameras in a minimal form factor or overall volume, depth, or thickness, which can be particularly advantageous when used inside machine tool safety enclosures, where efficient use of space can be particularly important.

For example, the spin windows described herein can have an overall depth or thickness of less than 6.00 inches. As another example, the spin window 100 can have an overall depth or thickness when installed, as measured from the surface to which the spin window 100 is installed along an axis perpendicular to that surface, which may or may not be aligned with the axis 110, of between about 3.00 and 3.50 inches, or about 3.25 inches. As a further example, the spin window 200 can have an overall depth or thickness when installed, as measured from the surface to which the spin window 200 is installed along an axis perpendicular to that surface, of between about 2.00 and 2.50 inches, or about 2.35 inches.

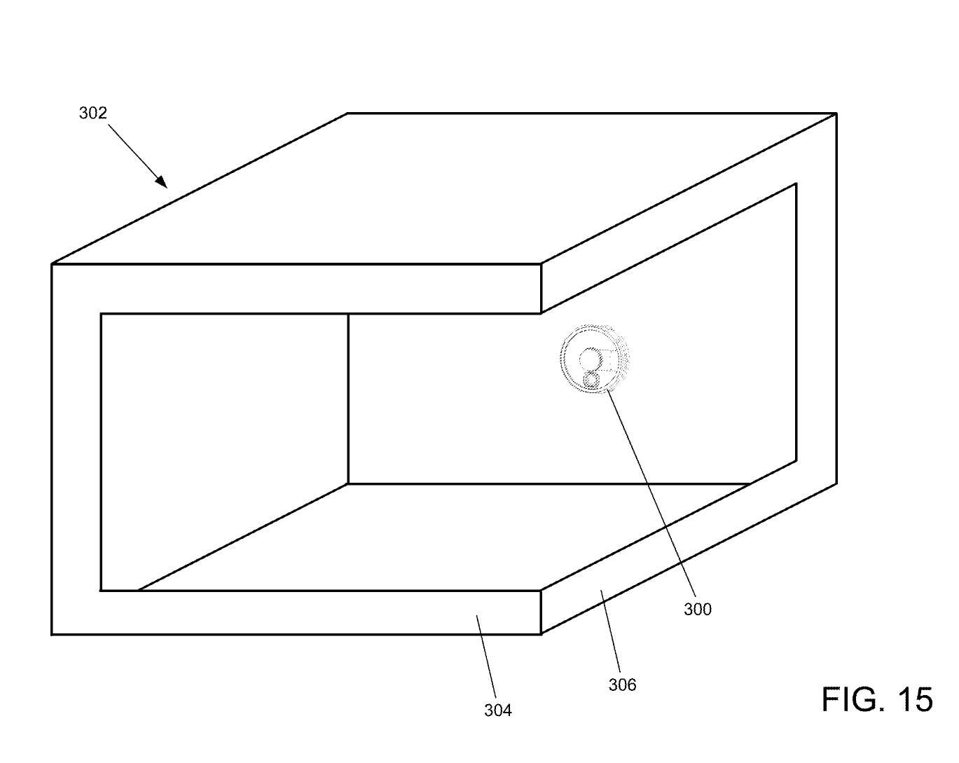

FIG. 15 shows that in some implementations, a spin window 300, which can include any of the features described above for spin windows 100 and 200, can be mounted within, such as to an outer wall of, a machine tool safety enclosure 302. The enclosure 302 is shown with an opening in a front outer wall 304 and a side outer wall 306 to more clearly illustrate the spin window 300, while in practice, the enclosure 302 can be sealed closed around the spin window 300. In some implementations, spin windows can be incorporated into the outer walls of such a machine tool safety enclosure 302. The spin windows 100, 200, and 300, however, can be installed so they are separate from the outer walls of the enclosure 302, so that an opening is not cut into one of the outer walls of the enclosure 302 to install the spin window 100, 200, or 300, and so that the spin window 100, 200, or 300 is completely enclosed within the outer walls of the enclosure 302.

In some embodiments, an existing spin window without an integrated camera, which may have already been used as described herein for spin windows generally, can be retrofitted to incorporate an integrated camera as described above for spin windows 100 or 200. In some embodiments, the spin windows 100, 200, or 300 can include antennas, so that they can be installed inside a machine tool safety enclosure and controlled by an operator standing outside the machine tool safety enclosure.

In some embodiments, the spin windows 100, 200, or 300 can incorporate control software that allows a human operator or a computer to control the operation of the spin window 100, 200, or 300. For example, the control software can provide control over a zoom, a tilt, a pan, a timestamp, and the motor of the spin window 100, 200, or 300. In some cases, any “industry 4.0” or “internet of things” protocol can be used to facilitate interaction with and control over the spin window 100, 200, or 300. In some cases, an MTConnect communications protocol can be used to facilitate interaction with and control over the spin window 100, 200, or 300, such as from an aggregating agent that also controls or monitors the operation of various machine tools, under an XML schema.

The cameras 108, 214 described herein can be any suitable type of camera. It has been found that internally-lensed, piezo-electrically actuated cameras, and cameras with a fixed depth or length that is independent of its focal length, can be particularly advantageous. Cameras referred to as “lipstick” cameras, or cameras having a “lipstick” form factor, or USB-type cameras can be particularly advantageous. One suitable example is a camera sold under the brand name GoPro Session.

The various embodiments described above can be combined to provide further embodiments. U.S. provisional patent application Ser. No. 62/385,807, filed Sep. 9, 2016, is incorporated herein by reference, in its entirety. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A spin window, comprising:
a rotatable, transparent window including an outer edge portion and a first central longitudinal axis;
a rotatable rim coupled to the outer edge portion of the rotatable, transparent window and including a second central longitudinal axis coincident with the first central longitudinal axis; and
a camera, wherein at least a portion of the camera is positioned directly radially inward from the rotatable rim.

2. The spin window of claim 1 wherein the at least a portion of the camera includes at least a lens of the camera.

3. The spin window of claim 1 wherein the spin window is completely enclosed within outer walls of a machine tool safety enclosure.

4. A spin window, comprising:
a rotatable, transparent window including an outer edge portion and a first central longitudinal axis;
a rotatable rim coupled to the outer edge portion of the rotatable, transparent window and including a second central longitudinal axis coincident with the first central longitudinal axis; and
a camera, wherein a first position of at least a portion of the camera overlaps with a second position of the rotatable rim along a dimension parallel to the first and second central longitudinal axes.

5. The spin window of claim 4 wherein the at least a portion of the camera includes at least a lens of the camera.

6. The spin window of claim 4 wherein the spin window is completely enclosed within outer walls of a machine tool safety enclosure.

7. A spin window, comprising:
a rotatable, transparent window including a first central longitudinal axis;
a motor coupled to the rotatable, transparent window and including a second central longitudinal axis coincident with the first central longitudinal axis; and
a camera, wherein at least a portion of the camera is positioned directly radially outward from the motor.

8. The spin window of claim 7 wherein the at least a portion of the camera includes at least a lens of the camera.

9. The spin window of claim 7 wherein the spin window is completely enclosed within outer walls of a machine tool safety enclosure.

10. A spin window, comprising:
a rotatable, transparent window including a first central longitudinal axis;
a motor coupled to the rotatable, transparent window and including a second central longitudinal axis coincident with the first central longitudinal axis; and
a camera, wherein a first position of at least a portion of the camera overlaps with a second position of the motor along a dimension parallel to the first and second longitudinal axes.

11. The spin window of claim 10 wherein the at least a portion of the camera includes at least a lens of the camera.

12. The spin window of claim 10 wherein the spin window is completely enclosed within outer walls of a machine tool safety enclosure.

13. A spin window, comprising:
a housing including an outer rim;
a notch formed in the outer rim;
a first bracket including a main body and a flange, the bracket coupled to the outer rim with the flange positioned in the notch;
a second bracket coupled to the first bracket; and
a camera coupled to the second bracket.

14. The spin window of claim 13 wherein the camera is sealed to the housing with a nitrile sleeve.

15. The spin window of claim 13 wherein the spin window is completely enclosed within outer walls of a machine tool safety enclosure.

16. A spin window, comprising:
an outer stationary rim;
a stationary support arm extending radially inward from the outer stationary rim;
a first protrusion coupled to and extending transverse to the stationary support arm;
a second protrusion coupled to and extending radially inward from the outer stationary rim; and
a camera constrained against lateral movement by the outer stationary rim, the stationary support arm, the first protrusion, and the second protrusion.

17. The spin window of claim 16 wherein the spin window is completely enclosed within outer walls of a machine tool safety enclosure.
